(19) United States
(12) Patent Application Publication
(10) Pub. No.: US 2024/0020654 A1
(43) Pub. Date: Jan. 18, 2024

(54) METHOD FOR MAINTENANCE PLANNING OF AIRCRAFT ENGINES

(71) Applicant: MTU AERO ENGINES AG, Munich (DE)

(72) Inventors: Sabine Punge, Munich (DE); Markus Wagner, Langenhagen (DE); Paul Janke, Langenhagen (DE); Carsten Hof, Munich (DE); Martin Friis-Petersen, Langenhagen (DE)

(21) Appl. No.: 18/247,448

(22) PCT Filed: Oct. 1, 2021
(86) PCT No.: PCT/DE2021/100791

§ 371 Date: Mar. 31, 2023

(30) Foreign Application Priority Data
Oct. 1, 2020 (DE) 10 2020 006 019.6

(51) Int. Cl. G06Q 10/20

(52) U.S. Cl. CPC G06Q 10/20

(57) ABSTRACT

A method for automatically generating an optimized maintenance plan for a fleet of aircraft engines, includes the steps of: acquiring input data on a plurality of engines and providing an existing initial maintenance plan or creating an initial maintenance plan based on the acquired input data. A total maintenance effort for the fleet resulting in an application of the initial maintenance plan is then determined. Next, the engines are sorted into a defined order according to at least one criterion and at least one optimization strategy or heuristic stored as an algorithm in a computer program is applied to each of the engines in the defined order. Next, an optimized maintenance plan for the engines or output data comprising an estimated total maintenance effort of the optimized maintenance plan is output.

### CROSS REFERENCE TO RELATED APPLICATIONS

This application is a U.S. National Phase application under 35 U.S.C. § 371 of International Application No. PCT/DE2021/100791, filed on Oct. 1, 2021, and claims benefit to German Patent Application No. 10 2020 006 019.6, filed on Oct. 1, 2020. The International Application was published in German on Apr. 7, 2022 as WO 2022/068997 A1 under PCT Article 21(2).

### FIELD

The present invention relates to a method for planning aircraft engine maintenance.

### BACKGROUND

In the technical field of maintenance and/or servicing of aircraft engines it is known that these are to be serviced according to fixed maintenance intervals. In addition, there may be additional workshop visits, so-called shop visits, which are carried out, for example, depending on a recorded or calculated engine condition or in the event of a (part) failure. The maintenance intervals are often specified by the engine manufacturer or the airline operating the engine.

The maintenance intervals specified by engine manufacturers are generally conservative and not optimized in terms of costs and/or maintenance effort. Against this background, approaches have been developed in the state of the art to optimize servicing/maintenance plans for individual engines by means of software. This approach is currently predominant in maintenance planning for aircraft engines. In such individual optimization, there may be conflicting external influencing factors that increase the complexity of the optimization. It is potentially possible to save effort by maximizing maintenance intervals, since it may be possible to save, for example, one shop visit over the entire lifetime of the engine. However, there is also the effect that later shop visits are usually more expensive (mainly due to rising material prices), so that, depending on the assumptions made, the optimum for the individual maintenance interval may be different.

If an entire engine fleet is taken into account, the optimum maintenance intervals for the individual engines of the fleet will generally be different from those of the same engines detached from the fleet. This results in a large optimization potential for engine fleets, which can be increased even more compared to the optimization of individual engines. However, due to the high level of complexity, optimization across an entire engine fleet and taking into account several external influencing factors also results in an NP-complete problem, which cannot be solved deterministically in a simple manner but requires sophisticated software solutions.

### SUMMARY

In an embodiment, the present disclosure provides a method for automatically generating an optimized maintenance plan for a fleet of aircraft engines. The method includes acquiring input data on a plurality of engines and providing an existing initial maintenance plan or creating an initial maintenance plan based on the acquired input data. A total maintenance effort for the fleet resulting from an application of the initial maintenance plan is then determined. Next, the engines are sorted into a defined order according to at least one criterion and at least one optimization strategy or heuristic stored as an algorithm in a computer program is applied to each of the engines in the defined order. Next, an optimized maintenance plan for the engines or output data comprising an estimated total maintenance effort of the optimized maintenance plan is output.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A shows a first embodiment of the present invention;

FIG. 1B shows a second embodiment of the present invention;

FIG. 1C shows a third embodiment of the present invention;

FIG. 2A shows an illustration of an initial maintenance plan; and

FIG. 2B shows an illustration of an improved maintenance plan

### DETAILED DESCRIPTION

With this in mind, the present invention provides an improved method for automated generation and optimization of a maintenance plan for a fleet of aircraft engines.

A first aspect of the present invention relates to a method, in particular a computer-implemented method, for automated generation of an optimized maintenance plan for a fleet of aircraft engines, the method comprising at least the following steps:
a) Acquiring input data on a plurality of engines, the data representing maintenance-related information for the fleet of aircraft engines individually and/or as a whole and, in particular, comprising an average service life (“Mean Time Between Shop Visits (MTBSV)”) or data relating to life-limited parts (LLP) of the engines of the engine fleet (but these data can also represent, for example, any time or technical boundary condition to be complied with for the maintenance of the aircraft engines and/or at least one influencing factor on the effort required for the maintenance of the fleet);
b) Providing an existing initial maintenance plan or creating an initial maintenance plan based on the acquired input data, especially the MTBSV and/or LLP data, for the engines;
c) Determining a total maintenance effort for the fleet in the case of an application of the initial maintenance plan, such as total costs or a total time effort or material effort;
d) Sorting the engines into a defined order according to at least one criterion, in particular according to an estimated maintenance effort or estimated maintenance costs (per engine);
e) Applying at least one optimization strategy or heuristic (exemplary optimization strategies are described later), which may in particular be stored as an algorithm in a computer program, to the respective engines of the engine fleet in the defined order; and
f) Outputting a maintenance plan for the engines optimized after application of step e) (the maintenance plan may in particular comprise maintenance intervals and scopes of the individual shop visits) and optionally additional output data comprising in particular an estimated total maintenance effort of the optimized maintenance plan, e.g. total costs or total time effort after optimization. Preferably, the method can take into account the influence that the applied optimization strategies for optimizing one of the engines has on the other engines of the fleet.

Such an optimization method according to the first aspect of the invention makes it possible to achieve a greater savings potential compared to individual optimization by pre-sorting the engines and considering the interactions between the engines of the fleet according to the expected effort. The aforementioned optimization strategies can be pre-programmed or pre-determined optimization algorithms and/or heuristics. An example of such a strategy could be an algorithm that reduces a shop visit in which LLPs are to be replaced in the maintenance plan to a shop visit without replacing the LLPs if the condition is met that fewer than 2 LLPs in no more than one engine module are affected.

According to a preferred embodiment, when performing step e), at least one optimization strategy can first be applied to the first engine, considering effects of this optimization on the other engines in the fleet (e.g., shift of shop visits, availability of spare parts, etc.), and then a total maintenance effort for the entire fleet can be determined after this sub step. In the case that the total maintenance effort for the entire fleet is reduced by applying the strategy to the first engine, the optimization can be maintained and advanced to the next engine in the fleet or, if a predetermined termination criterion is met, the optimization could also be terminated at this point. In the event that the total maintenance effort for the engine fleet is not reduced by applying the strategy to the first engine, either a different strategy could be applied to the first engine, or the optimization could be advanced to the next engine without optimizing the first engine, or the optimization could be terminated. Thus, in a further preferred embodiment, optimization of the individual engines can be performed in the pre-sorted order, with interactions between the engines being included in the consideration. In an alternative embodiment, when applying the selected optimization strategies sequentially, a strategy would not be applied to an engine, if doing so would alter a maintenance plan of an engine that has already been optimized previously. Such a further refined optimization method according to the first aspect makes it easier compared to the conventional optimization method to find an optimum at the fleet level, to take synergies into account, and thus to achieve greater overall optimization or cost savings than could be achieved by individually optimizing each single engine.

According to a preferred embodiment of the invention, after sequentially applying at least one optimization strategy or heuristic to each of the engines according to step e), the engines can be sorted again according to step d) depending on the at least one criterion and, after this step, an optimization strategy or combination of optimization strategies can be applied again to the respective engines in the newly determined order.

In a further preferred embodiment of the invention, output data, in particular an estimated total maintenance effort or estimated total costs, can also be output in step f) in addition to the optimized maintenance plan. In this case, steps d) and e) can be iterated until a predetermined termination criterion is met on the basis of the above-mentioned output data, for example a reduction in working time or a reduction in costs by a defined percentage. Alternatively, for example, a predetermined number of iteration cycles may be defined as a termination criterion. Preferably, the engines of the fleet can be re-sorted according to the at least one criterion before each new iteration.

In another preferred embodiment, a different optimization strategy or heuristic may be applied during each iteration. Different planning strategies may also be combined during the iterations. Here, the individual aircraft engines can each be optimized individually or also as a collective, since the planning strategies for each individual aircraft engine can also have an influence on the overall planning strategy of all aircraft engines in a fleet. Accordingly, the applied method or algorithm calculates combinations which, step by step in an iterative process, lead to low total operating costs. For each maintenance plan, which is determined by the method in the individual iteration steps, different maintenance strategies can be selected and applied independently of each other. In a preferred embodiment, the results generated from the individual iterations can be compared with each other, in particular with the respective previously determined maintenance plan. If an applied optimization strategy results in a worse result/output value than the previously determined maintenance plan, the algorithm can jump back to that previous plan and apply an alternative optimization strategy to it. Therefore, a user does not have to manually determine and establish in advance the strategies and synergies between the individual maintenance plans of the individual aircraft engines and sub-fleets, rather these are iteratively identified in an automated manner by the method. In other words, the method according to the invention may have a selection of predefined or preprogrammed optimization strategies, each of which is then sequentially applied to the individual engines of the fleet and cycled through in multiple iterations until a specific termination criterion is met or a local optimum is reached.

In some embodiments, the iterative optimization in each iteration may further comprise the step of: determining the optimized maintenance plan associated with that iteration for the fleet based on an aggregation of the individual maintenance plans resulting from that iteration with respect to the individual aircraft engines.

By individually optimizing each aircraft engine's maintenance plan, the maintenance plan for the fleet can also be further optimized.

In some embodiments, an interaction of maintenance measures for individual aircraft engines may be considered for determining the maintenance plan and/or for determining the respective individual maintenance plans. For example, the availability of an aircraft engine as input data may have the result that an aircraft engine to be replaced can be replaced by the available aircraft engine at a particular time, whereas another aircraft engine to be replaced may not be replaced until a later time because the required available aircraft engine is already scheduled for earlier replacement and a further aircraft engine must first be procured.

According to a second aspect of the invention, there is a method provided, in particular a computer-implemented method, for automated generation of an optimized maintenance plan for a fleet of aircraft engines, the method comprising at least the following steps:
a) Acquiring input data on a plurality of engines representing information specific to the individual aircraft engines and/or related to the entire fleet and comprising, in particular, a “Mean Time Between Shop Visits (MTBSV)” or data relating to life-limited parts (LLP) of the engines;
b) Providing an existing initial maintenance plan or creating an initial maintenance plan based on the acquired input data, especially the MTBSV and or LLP data, for the engines (E1, E2, E3, E4);
c) Calculating a total maintenance effort for the fleet in the case of an application of the initial maintenance plan;
d′) Optimizing the initial maintenance plan using a self-learning algorithm trained for this purpose; and
f) Outputting an optimized maintenance plan for the engines after application of step d′) and/or output data comprising, in particular, an estimated total maintenance effort of the optimized maintenance plan. The trained algorithm may be based on machine learning and may include a neural network. The trained algorithm can, for example, be trained on manually optimized data sets or based on the results of the automated iterative optimization process for engine fleet maintenance plans described above.

According to a third aspect of the invention, the automated iterative approach may be combined with the machine learning based approach. For this purpose, for example, an automated iterative maintenance plan created according to the first aspect of the invention can be used as the initial maintenance plan for a machine learning based optimization method or vice versa. In this case, the automated iterative approach provides one with a good starting point from which the machine learning based algorithm can quickly converge to a further optimized solution.

In all embodiments described above, the input data may preferably include at least one data set from the group: mean time between shop visits (MTBSV); the time required and/or costs (work scope) of respective types of shop visits; data regarding life-limited parts (LLP) of the engines (E1, E2, E3, E4), in particular remaining cycles of the LLPs; engine type; replaceable small parts; availability of used and/or new spare parts; costs of used and/or new spare parts; technical specifications of the aircraft engines; the time interval for each aircraft engine since initial certification or since the last shop visit; the availability of the same type of the respective aircraft engines scheduled for maintenance.

One or more of these input data can be used to create the maintenance plan. Other input data/input variables may result in completely different maintenance plans for the respective individual aircraft engine or for the fleet.

In any of the embodiments described above, the output data output in step f) or f) may include one or more data sets selected from the group: next maintenance date of aircraft engines; need for spare and short-term leasing engines for the next maintenance; material requirements for the next maintenance; labor requirements for the total maintenance plan; total costs (total cost of ownership) for the engine fleet; cost per flight hour for the engine fleet and/or cash flow.

The provision of at least one of these data enables the specific assignment of the aircraft engines to an action concerning maintenance.

In any of the embodiments described above, the total maintenance effort used when comparing the initial maintenance plan to the optimized maintenance plan may represent the labor effort or the material effort or total costs of the fleet. In some embodiments, the total maintenance effort represents the labor effort or the material effort. In this regard, the labor effort may include the total labor hours required to perform the maintenance, the personnel required to perform the maintenance, or the costs incurred by the labor hours and/or the material required. The material costs may include the required spare parts as well as their logistical delivery to the maintenance site. Methods for deriving these values from a maintenance plan are known, for example, from U.S. Pat. No. 8,744,864 B2.

According to a further preferred aspect of the invention, the input data may include qualified estimates of market developments, such as the availability of material/spare parts on the market; the material costs as well as material cost development or the availability and costs of external spare engines and/or green time engines or leasing engines. In this case, the method can be set up to automatically output optimized maintenance plans for different scenarios. For example, for good, neutral and bad price development on the material market.

Another aspect of the invention relates to a method for optimized maintenance of an engine fleet, wherein an optimized maintenance plan is first created or obtained according to any of the aforementioned aspects, and subsequently the engine fleet is maintained, repaired and/or overhauled according to the optimized maintenance plan.

A further aspect of the invention relates to the automated execution of the above-described methods for optimizing maintenance plans for engine fleets by computers or other means of data processing. Such a means in the sense of the present invention can be designed in terms of hardware and/or software, in particular having a processing unit, in particular a microprocessor unit (CPU), which is data-connected or signal-connected, preferably to a memory and/or bus system, and/or one or more programs or program modules. The CPU can be designed to process instructions implemented as a program stored in a memory system, to acquire input signals from a data bus and/or to output signals to a data bus. A memory system may have one or more, in particular different, storage media, in particular optical, magnetic, solid state and/or other non-volatile media. The program may be such that it embodies or is capable of executing the methods described herein, such that the CPU can execute the steps of such methods.

In one embodiment, a computer program product may have, in particular be, a storage medium, in particular a non-volatile storage medium, for storing a program or having a program stored thereon, wherein executing said program causes a system and/or a controller in particular a computer, to execute a method described herein and/or one or more of its steps.

In one embodiment, one or more, in particular all, steps of the method are performed in a fully or partially automated manner, in particular by a computer or other data processing system.

Another aspect of the present invention relates to a computer program configured to perform the method according to the first aspect.

Another aspect of the invention relates to an apparatus for automated generation and optimization of an aircraft engine maintenance plan, wherein the apparatus is configured to perform the method according to the first aspect.

Further advantages, features and possible applications of the present invention will be apparent from the following detailed description in connection with the figures.

Throughout the Figures, the same reference numerals are used for the same elements of the invention or for elements corresponding to each other.

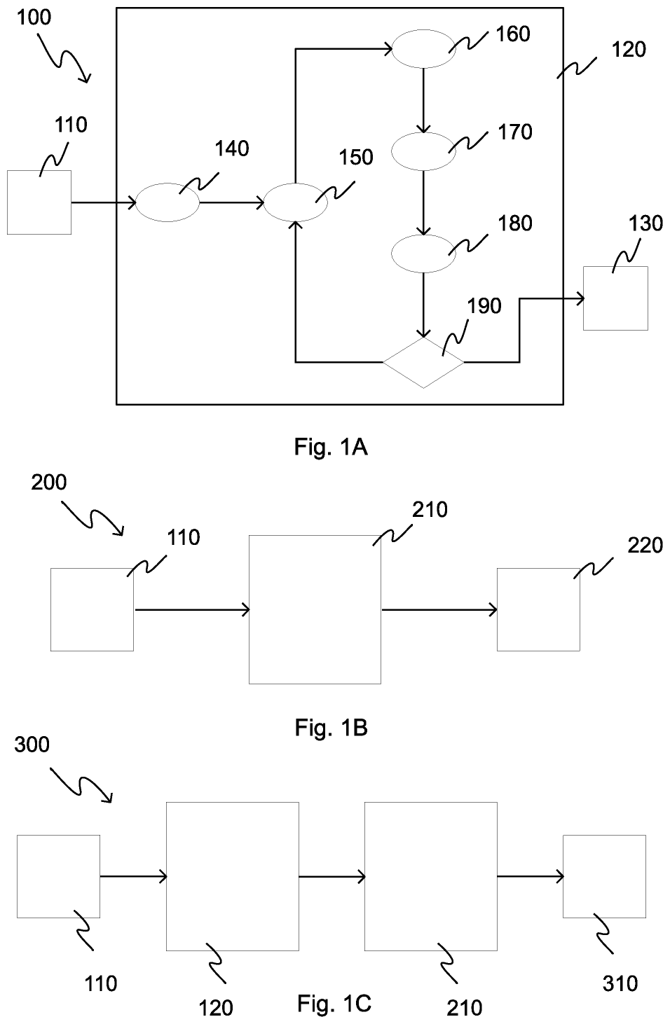

FIG. 1A shows a first embodiment of a method 100 for automated generation of an optimized maintenance plan for an engine fleet according to the present invention. In the present example, the method 100 is computer-implemented. For illustrative purposes, the engine fleet in the present example comprises only aircraft engines E1, E2, E3, E4.

In a first step of the method, input data 110 are recorded in a database, each relating to one or more aircraft engines E1, E2, E3, E4. The input data 110 may represent aircraft engine fleet data, customer data, manufacturer specifications, maintenance, repair and overhaul data, data related to costs and price developments, technical specifications of the respective aircraft engines, or market forecast data. In particular, manufacturer specifications such as service life or airline maintenance strategies are taken into account. Furthermore, technical and commercial information concerning repair, maintenance and overhaul is taken into account.

The general engine data and/or data on the engine fleet can, for example, include one or more elements from the following list: engine type, Time Since New (TSN), Cycles Since New (CSN), Time Since Last Shop Visit (TSLSV), Cycles Since Last Shop Visit (CSLSV), entry into service date, phase out date/end of life, status of life-limited parts (LLPs), in particular remaining cycles for the individual parts, remaining engine performance or the configuration of the engine.

The manufacturer's specifications may include, for example, prescribed life limits on various parts, mandatory inspections, part numbers and engine configuration data.

Customer data (usually an airline) may include, for example: availability of spare engines or parts; data on the operated flight routes.

Maintenance, repair, and overhaul data, in particular, may be based on the technical experience of and the input from the operator of the optimization program. These may include, for example: experience-based effort (work scope) of certain types of shop visits; cost development of shop visits; time availability of capacities for shop visits or the mean time between shop visits/On Wing Time.

Qualified estimates of market development may include: availability of material/spare parts on the market; material costs as well as material cost development; availability and costs of external spare engines and/or green time engines or leasing engines.

After the input data 110 have been acquired, an initial maintenance plan 140 with predetermined maintenance intervals between shop visits and/or from beginning of operation for the aircraft engines E1, E2, E3, E4 is created as part of chronological forward planning. The predefined maintenance intervals may be specified by the customer or may be based on a maximum maintenance interval specified by the manufacturer or by law. Alternatively, for example, an initial maintenance plan 140 specified by the customer could be entered into the method as an input data set, or the initial maintenance plan 140 could be created based on other input data, such as the remaining cycles of the life-limited parts or the mean time between shop visits.

To further optimize this initial maintenance plan 140, an automated iterative algorithm 120 is run in the embodiment example of FIG. 1A. In a first step 150 of the iterative algorithm 120, a maintenance effort is estimated according to a predetermined criterion for each of the aircraft engines E1, E2, E3, E4, and the aircraft engines are then sorted according to the expected effort (in descending order). This allows the engine with the highest expected effort and thus with the highest presumed savings potential to be considered first in the next step. The expected effort can be a value generated on the basis of the initial maintenance plan for the individual engines. For example, a maintenance duration, estimated maintenance costs, material efforts or a combination of these can be stored for individual operations, which are then cumulated or converted into a parameter in some other way.

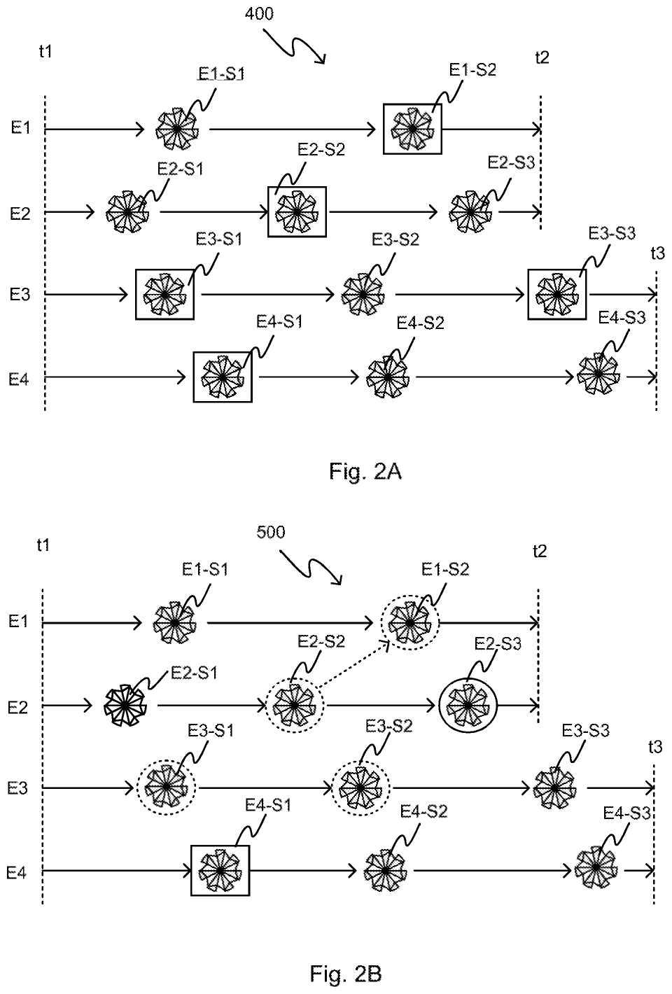

In the next step 160, a predefined optimization strategy and/or heuristic H1, H2, H3, H4 is executed on the engine (e.g. E1) with the highest expected maintenance effort. Sample optimization strategies H1, H2, H3, H4 will be described in more detail later. Interactions with the maintenance plans of the other engines in the fleet are taken into account (e.g. available spare parts or time slots in the assembly shop). After applying one or more of these optimization strategies to the first engine E1, the program checks whether the total maintenance effort for the engine fleet has been reduced compared to the initial maintenance plan, taking into account the respective individual maintenance plans for engines E1, E2, E3, E4 (see FIG. 2). If the total maintenance effort has decreased, the optimization strategy maintains the changes to the maintenance plans and the algorithm proceeds to optimize the next engine. If the total maintenance effort has not decreased or has worsened, changes to the maintenance plans are discarded by the optimization strategy and the algorithm either selects another optimization strategy H1, . . . , H4 or continues with the next engine if no more stored optimization strategies are available.

In the following step 170, one of the predefined and/or preprogrammed optimization strategies H1, . . . , H4 is calculated for the engine (e.g. E2) with the second-highest expected maintenance effort, and if there is a further improvement in the total maintenance effort of the fleet, it is also applied, as already described in step 160. This procedure is repeated for each engine in turn until the last engine in the fleet has been considered (step 180). In other words, the program iterates through optimization strategies for each engine E1, E2, E3, E4 in turn until an improvement is achieved for the entire engine fleet.

Following this iteration run in steps 160-180, a decision is made in step 190 on the basis of a comparison of the optimization achieved with a predefined boundary condition (e.g. a predefined number of iteration cycles or a predefined desired percentage effort reduction) as to whether another iteration should be performed. If another iteration is to be performed, an updated sorting 150 of the aircraft engines is performed based on the expected effort per engine E1, E2, E3, E4, i.e. the engines are again sorted in descending order of effort/costs. The engines are then optimized again iteratively in sequence as described above.

In the case that the comparison 190 shows that no further iteration should take place, the output data 130 are output. Termination criteria could be, for example, that a target optimization has been achieved or that no more improvement has been achieved in the last x iteration cycles.

The output data can represent predictions about planned maintenance dates, predictions about required material, as well as predictions about the total operation costs (total cost of ownership). Methods for generating such characteristic data or output data from a maintenance plan are known to the skilled person, for example, from U.S. Pat. No. 8,744,864 A.

In summary, in iterative optimization an initial maintenance plan is optimized iteratively. For this purpose, first, a maintenance plan is defined that is assigned to the respective iteration. In each iteration, the engines are sorted into a specific sequence and processed one after the other according to a predetermined optimization strategy. From this, a modification can be made with regard to the type or timing of the maintenance measures to be performed with respect to the individual aircraft engines if an improvement is identified by applying the optimization strategy. The modification of the type of maintenance measure here can mean, for example, a change from repairing a part of an aircraft engine that was scheduled in the previous iteration to replacing the part with a spare part for the current iteration.

For further improvements of the optimization procedure, a choice can be made between automated iterative processing, as described above, and an algorithm based on artificial intelligence, see FIG. 1B.

FIG. 1B shows a second embodiment of the present invention. During the automatic iterative processing according to FIG. 1A, the number of possible planning strategies increases very quickly with the number of engines in the fleet, so that not all options can be explicitly calculated. Therefore, as an alternative or supplement to the automated iterative processing, a method based on artificial intelligence (AI) 210 is provided. Here, the input data 110 described above are processed using a trained self-learning algorithm, for example a tree-based algorithm, to generate output data 220 based on AI. The algorithm may, for example, be manually trained by feeding it with the input data and the respective optimized maintenance plans and output data sets created by an experienced maintenance planner. Alternatively, it can be trained using existing data sets from the iterative automatic optimization process described above according to the first embodiment. In this process, the algorithm learns which decisions (which optimization strategies H1, H2, etc.) are more promising than others in which situations, and uses them preferentially. The processing by AI can be activated or deactivated by a user.

FIG. 1C shows a third embodiment of the present invention. Here, a method using automated iterative processing and AI to generate a maintenance plan is schematically shown. Here, the input data 110 are successively processed by the automated iterative algorithm 120 and AI-based algorithm 210. It is also conceivable that a processing by the AI-based algorithm 210 occurs first, followed by a processing by the automated iterative algorithm 120. From this, output data 220, 310 are generated. It is also conceivable to set the intensity with which the AI-based algorithm tracks strategies H1, H2, etc., or to preset strategies which are to be tracked, for example by a user. The use of both algorithms, i.e. automated iterative and AI-based, is advantageous for particularly demanding models that require a lot of computing power.

The methods described in FIGS. 1A, 1B, and 1C also enable the selection of the appropriate maintenance plan for an aircraft engine fleet from a variety of applicable planning strategies. These include adjusting the average time between maintenance dates, life-limited parts (LLPs) allocations, and using new or previously used aircraft engines from within the company or from an outside firm. In addition, different conditions and/or restrictions specific to a particular aircraft engine fleet can be defined. Likewise, phase-out scenarios and conditions for the optimization can be defined and adapted.

Considering all input data and boundary conditions, a prediction for a maintenance date can be determined, minimizing the total operating costs for each individual aircraft engine and the aircraft engine fleet.

FIG. 2A shows an exemplary illustration of an initial maintenance plan 400, where the required shop visits for four aircraft engines E1, E2, E3, E4 are each shown on a time axis between a start time t1 and an end time t2 or t3, which may be the end of life (EOL) of the respective aircraft engine. In the example shown, the engines E1 and E2 have point in time t2 as the end of their life cycle and the engines E3 and E4 have the later point in time t3.

The respective status of the engines for a scheduled shop visit is indicated in the format Ex-Sy, where “x” represents the number of the aircraft engine and “y” represents a sequential number for the respective shop visit. Accordingly, E1-S2 represents the status of the aircraft engine 1 at the second shop visit in the created initial maintenance plan 140.

Furthermore, the shop visits are marked with an engine symbol, which symbolizes the scope of work (work scope) of the respective shop visits. Without further marking, the symbol stands for a performance restoration as shown for example in E1-S1, FIG. 2A. This can be a less costly maintenance operation where no parts need to be replaced, but only minor tasks are involved, e.g. the restoring of blade edges. If the symbol is enclosed in a square, it is a shop visit where life-limited parts (LLPs) need to be replaced (or will soon need to be replaced) with new parts, see for example E1-S2, FIG. 2A, which is a more costly operation than performance restoration due to material costs and labor. If the symbol is enclosed in a dashed circle, this means a shop visit where life-limited parts (LLPs) are replaced with used parts, see for example E1-S2, FIG. 2B.

The intervals between the individual shop visits of an aircraft engine symbolize the time interval to the next maintenance appointment. In this way, the time intervals for different aircraft engines can be compared, as well as the sequence in which they have to be brought into the shop for maintenance.

FIG. 2B shows an exemplary illustration of a maintenance plan 500 improved by means of a method according to an embodiment of the present invention. Exemplary optimization strategies that can be used in the context of one of the above-mentioned methods will be explained below using this example.

Among other things, this is meant to illustrate how different planning strategies can be combined to optimize an engine fleet in terms of expected maintenance effort or total operation costs.

The engines in the fleet were sorted in descending order (E1-E4) according to the estimated maintenance effort and/or maintenance costs as described in step 150 above. The automated iterative algorithm begins by searching for a suitable optimization strategy for engine E1.

A first planning strategy or heuristic H1 that is applied checks for the more elaborate category of shop visits, where, according to manufacturer specifications, life-limited parts (LLPs) are to be replaced by new parts, whether the appropriate LLPs with sufficient remaining service life can be found in one of the other engines of the fleet. In the present example, the initial maintenance plan 400 for shop visits E1-S2, E2-S2, E3-S3, E3-S3 and E4-S1 provides for such replacement of LLPs with new parts. In doing so, the algorithm ensures that LLPs with sufficient residual cycles are available in the E2 engine at a suitable time to be used in the E1 engine for the E1-S2 shop visit, since only a few residual cycles are left on the corresponding parts of the E1 engine. By transferring these used LLPs present in the engine fleet from engine E2 to engine E1 (dashed slanted line in maintenance plan 500), engine E1 can continue to operate without the use of additional new parts until its scheduled decommissioning (EOL) at point in time t2. After applying this strategy, the program checks whether the measure has reduced the total maintenance effort. Since this test is positive, the program continues with the second engine E2.

The program does not see any applicability for optimization strategy H1 at engine E2 and therefore checks second planning strategy H2. This optimization strategy checks in turn for all engines E1, E2, E3, E4 for each shop visit where, according to the manufacturer's specifications, service life-limited parts (LLPs) are to be replaced by new parts, whether suitable LLPs with sufficient remaining service life can be obtained second-hand on the open market and at what price this is possible. In the present example, this strategy determines that new parts can be dispensed with in shop visit E2-S2 by sourcing used LLPs from the market. Since this results in an overall improvement in costs, this optimization is adopted. Similarly, the strategy recognizes that for shop visit E3-S1, new parts can be dispensed with by sourcing used LLPs from the market.

For engine E3, the program determines that a third planning strategy H3 could be applied. Strategy H3 checks in turn to see if a shop visit to replace life-limited parts (LLPs) with new parts can be dispensed with by increasing the scope of maintenance (work scope) of the preceding shop visit. For engine E3, the algorithm uses this strategy to determine that by replacing some LLPs early with used parts in better condition in the preceding shop visit E3-S2, a less costly “performance restoration” in the last scheduled shop visit E3-S3 is sufficient to get through to the decommissioning of E3 at the point in time t3. This avoids having to purchase new parts shortly before the decommissioning EOL of the E3 engine, thereby “wasting” their life cycles. This also results in an improvement in the overall view of the fleet and this change is therefore applied.

For engine E4, the program is unable to find an individual optimization that would further reduce the effort required for the entire fleet. An iteration loop is thus completed.

After this iteration loop, the program applies a fourth planning strategy H4 in a second iteration loop. This checks in turn for all engines E1, E2, E3, E4 whether shop visits, which are due shortly before an engine is decommissioned, can be dispensed with. This strategy determines that the total costs can be reduced by decommissioning engine E2 more quickly instead of the shop visit E2-S3 and using a spare engine (engine symbol with closed circle in FIG. 2B) for the short remaining time at this point (for this purpose, it is possible, for example, to query the engine symbol with a closed circle in FIG. 2B). Alternatively, it can be compared whether the leasing costs for an external engine stored in the input database are lower than the estimated costs for a performance restoration).

Although exemplary embodiments have been explained in the preceding description, it should be noted that a variety of variations are possible. Furthermore, it should be noted that the exemplary embodiments are merely examples that are not intended to limit the scope of protection, the applications or the construction in any way. Rather, the foregoing description provides the skilled person with a guide for implementing at least one exemplary embodiment, wherein various modifications, particularly with respect to the function and arrangement of the described parts, may be made without departing from the scope of protection as it results from the claims and these equivalent feature combinations

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

100 method with an automated iterative algorithm
110 input data
120 automated iterative algorithm
130 output data
140 forward planning
150 aircraft engine sorting
160 optimization of a first aircraft engine
170 optimization of a second aircraft engine
180 optimization of a further aircraft engine
200 method based on artificial intelligence
210 algorithm based on artificial intelligence
220 output data based on artificial intelligence
300 method with an automated iterative algorithm and with artificial intelligence
310 output data based on combined algorithms
400 initial maintenance plan
500 optimized maintenance plan
E1-E4 respective aircraft engines
t1, t2, t3 points in time concerning the status of the respective aircraft engines
E1-S1 to E4-S3S respective status of the respective aircraft engine
H1-H4 optimization strategies/heuristics

1. A method for automatically generating an optimized maintenance plan for a fleet of aircraft engines, the method comprising at least the following steps:
a) acquiring input data on a plurality of engines, the data comprising a mean time between shop visits (MTBSV) or data relating to life-limited parts (LLP) of the engines;
b) providing an existing initial maintenance plan or creating an initial maintenance plan (140) based on the acquired input data;
c) determining a total maintenance effort for the fleet resulting from an application of the initial maintenance plan;
d) sorting the engines into a defined order according to at least one criterion;
e) applying at least one optimization strategy or heuristic stored as an algorithm in a computer program to each of the engines in the defined order; and
f) outputting an optimized maintenance plan for the engines after application of step e) and/or outputting output data comprising an estimated total maintenance effort of the optimized maintenance plan.

2. The method according to claim 1, wherein in step e), for each application of an optimization strategy to an engine, influences on the other maintenance plans are determined and the changes made by the optimization strategy are adopted only if the total maintenance effort for the engine fleet is thereby reduced.

3. The method according to claim 1, wherein in step f), the optimized maintenance plan and output data comprising the estimated total maintenance effort for the engine fleet are output, and further comprising iterating steps e) and f) until a predetermined termination criterion is satisfied on the basis of the output data.

4. The method according to claim 3, further comprising, before each iteration of steps e) and f), sorting the engines again according to step d) according to the at least one criterion.

5. The method according to claim 3, wherein a different optimization strategy or heuristic is applied at each iteration.

6. A method for automatically generating an optimized maintenance plan for a fleet of aircraft engines, the method comprising at least the following steps:
a) acquiring of input data on a plurality of engines comprising a mean time between shop visits (MTBSV) or data relating to life-limited parts (LLP) of the engines;
b) providing an existing initial maintenance plan or creating an initial maintenance plan based on the acquired input data;
c) determining a total maintenance effort for the fleet resulting from an application of the initial maintenance plan;
d′) optimizing the initial maintenance plan using a self-learning algorithm trained for that purpose; and
f) Outputting an optimized maintenance plan for the engines after application of step d′) and/or outputting output data comprising an estimated total maintenance effort of the optimized maintenance plan.

7. (canceled)

8. The method according to claim 6, wherein the input data represent at least one data set selected from the group:
mean time between shop visits;
the time required and/or the costs of each type of shop visit;
data regarding life-limited parts of the engines, in particular remaining cycles of the LLPs;
engine type;
availability of used and/or new spare parts;
cost of used and/or new spare parts;
technical specifications of aircraft engines;
the time interval for each aircraft engine since initial registration or since the last shop visit; and
the availability of the same type of the respective aircraft engines scheduled for maintenance.

9. The method according to claim 6, wherein the output data comprise one or more data sets selected from the group:
next maintenance time of the aircraft engines;
need for spare and short-term lease engines for the next maintenance;
material requirements for the next maintenance;
working time requirement for the total maintenance plan;
total costs for the engine fleet;
cost per flight hour for the engine fleet; and
cash flow.

10. The method according to claim 6, wherein the total maintenance effort represents the labor effort or the material effort or the total cost of ownership of the fleet.

11. The method for optimized maintenance of a fleet of engines, wherein an optimized maintenance plan according to claim 1 is first prepared or obtained and subsequently the fleet of engines is maintained, repaired and/or overhauled according to the maintenance plan.

12. A computer program configured to perform the method according to claim 1.

13. An apparatus for automated generation and optimization of an aircraft engine maintenance plan, wherein the apparatus is configured to perform the method of claim 1.
